(19) United States
(12) Patent Application Publication
(10) Pub. No.: US 2009/0245572 A1
(43) Pub. Date: Oct. 1, 2009

(54) Control apparatus and method

(75) Inventor: Shu-Jung Tsao, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/318,449

(22) Filed: Dec. 30, 2008

(30) Foreign Application Priority Data
Apr. 1, 2008 (TW) 097100291

(51) Int. Cl. G06K 9/00; G09G 5/08

(52) U.S. Cl. 382/103; 345/157

(57) ABSTRACT

The invention discloses a control apparatus for a user to control an electronic apparatus. The control apparatus of the invention includes a monitoring module, a sensing module, a first processing module, and a first transmitting module. The monitoring module is used to monitor the user's eyeball(s), and generates related eyeball-movement information. The sensing module is used to monitor a body portion of the user, and generates related body portion-movement information. The first processing module is connected to the monitoring module and the sensing module respectively, for calculating the control information in accordance with the eyeball-movement information and the body portion-movement information. Additionally, the first transmitting module is connected to the first processing module, for transmitting the control information to the electronic device, which can act according to the control information.

### BACKGROUND OF THE INVENTION

1. Field of the Invention

The present invention relates to a control apparatus and method; and more particularly, to a control apparatus and method operated by the movement of eyeballs and human body.

2. Description of the Prior Art

Because of the enhancement of life quality as well as the improvement of technologies, a lot of electrical appliances and electronic products which can enhance life quality and efficiency are getting popular. Moreover, some of the electronic products are designed for our visual sense, for example, 3D movie broadcast equipment or virtual reality systems which can increase the presentation; large-scale screen eye-closed type display equipments (for example, the binocular display module [BDM] published by Kopin and Solomon Systech International Limited) with the advantages of convenience and lightness; along with other watching or browse equipments.

Besides, methods and related apparatus for controlling or interacting electronic products by detecting the movement of eyeballs have been disclosed in, for example, Taiwan Patent Publication No. 00499306 entitled “The method of pursuing the pupil via cross-line orientation function,” and Taiwan Patent Publication No. 00497065 entitled “The method and apparatus of vision choosing the cursor of the window.”

In the prior art, detection of the movement of eyeballs is proceeded by using pupil tracking devices, such as the piezoelectric pupil tracking device, the optical pupil tracking device and the magnetic field pupil tracking device. Wherein, the piezoelectric pupil tracking device detects the direction of the ocular movement by the changes of the intraocular pressure. The detecting method is mainly pasting the piezoelectric material around the eyes; switching the intraocular pressure to the electrical signal via the piezoelectric sensor; and finally, treating and interpreting the obtained voltage signal. However, because of the piezoelectric pupil tracking device senses by current, it's easy to affect the interpretation of the signal due to perspiration or other factors. The magnetic field pupil tracking device is similar to the piezoelectric one, and its principle is to form the magnetic field around the eyeballs to interpret the ocular activities.

Besides, the optical pupil tracking device records the movement of the pupil via the optical elements such as infrared device, charge-couple device, etc., and analyzes the moving record of the pupil via the analysis apparatus, then it calculates the information such as the moving direction, the distance and the angle of the pupil's central point.

However, because the moving range of human's eyeballs is narrower, it is not easy to be recognized precisely by the optical detection device. Moreover, it is easy for the optical detection device to erroneously judge the position of the pupil due to the influences of the shadow around the eyes, the eyebrows or the eyelashes. And the actions of human body's activity, eyeballs beating, blinking, and so on, will also affect the judgment of the optical pupil tracking device. In addition, it's easy to produce ill symptom of eye strain for a user if it keeps monitoring the movement of the user's eyeballs.

### SUMMARY OF THE INVENTION

Accordingly, an aspect of the present invention is to provide a control apparatus and method, which control or interact with the corresponding electronic apparatus via the movement of the eyeballs. Particularly, besides detecting the activities of the eyeballs, the control apparatus and method of the invention also detect the human body's activities to assist the same, so as to solve the abovementioned problem.

According to a better embodiment, a control apparatus of the invention is for a user to control an electronic apparatus. The control apparatus comprises a monitoring module, a sensing module, a first processing module and a first transmitting module. The monitoring module is for the monitoring of the user's eyeballs and generating corresponding eyeball-movement information, while the sensing module is for sensing a body portion of the user, and generating a corresponding body portion-movement information. The first processing module is connected with the monitoring module and the sensing module respectively, and, according to the eyeball-movement information and the body portion-movement information, calculates the control movement information. Besides, the first transmitting module is connected with the first processing module for transmitting the control movement information to the electronic apparatus. When the electronic apparatus receives the control movement information, it carries on an action according to the control movement information.

According to a better embodiment, a control method of the invention is for a user to control an electronic apparatus. The control method comprises next steps: firstly, monitoring the user's eyeballs and generating a corresponding eyeball-movement information. Besides, sensing a body portion of the user and generating a corresponding body portion-movement information. Next, according to the eyeball-movement information and the body portion-movement information, a control movement information is calculated and formed. Finally, the control movement information is transmitted to the electronic apparatus and it drives the electronic apparatus to carry on an action according to the control information.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1 is a functional block diagram illustrating the control apparatus according to an embodiment of the invention.

FIG. 2 is a functional block diagram illustrating the control apparatus according to an embodiment of the invention.

FIG. 3 is a flow chart illustrating the control method according to an embodiment of the invention.

FIG. 4A is a flow chart illustrating the control method according to an embodiment of the invention.

FIG. 4B is a flow chart illustrating the control method according to an embodiment of the invention.

### DETAILED DESCRIPTION OF THE INVENTION

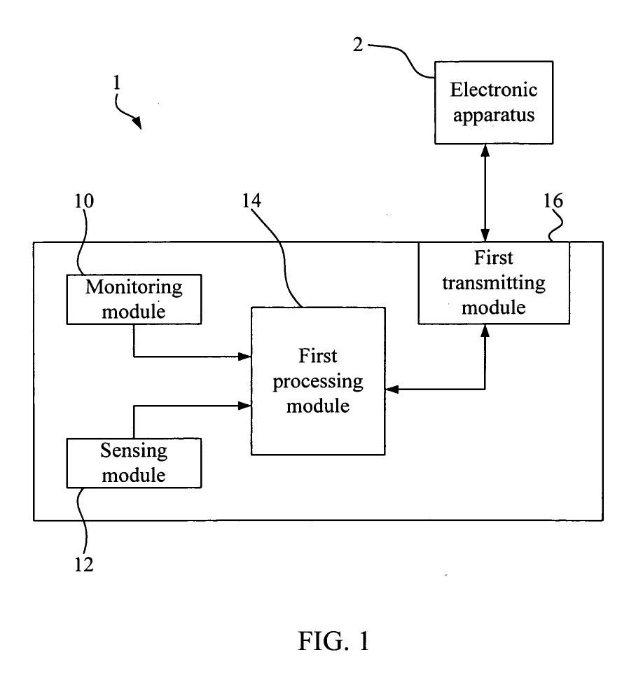

Please refer to FIG. 1, which is a functional block diagram illustrating the control apparatus according to an embodiment of the invention. As shown in FIG. 1, the control apparatus 1 comprises a monitoring module 10, a sensing module 12, a first processing module 14 and a first transmitting module 16.

The control apparatus 1 can be applied for a user to control an electronic apparatus 2. The electronic apparatus 2 is not limited to an information processing system such as a computer, a mobile phone or a personal digital assistant; an electrical appliance such as a TV, a game machine, a video or it can be an air-conditioning equipment; a weapon system such as a fighter pilot controlling the missile launching, or other suitable electronic apparatuses.

In practice, the control apparatus 1 of the invention is a wearable structure such as a pair of glasses or a headgear structure. Besides, the monitoring apparatus 10, the sensing module 12, the first processing module 14, the first transmitting module 16 and other modules or devices can be integrated on the wearable structure. In addition, the control apparatus 1 of the invention can be combined with other wearable objects to facilitate a user to have activities when operating or wearing the control apparatus 1. For example, the control apparatus 1 of the invention can be combined with objects like a pair of eyeglasses, a hard helmet, a safety helmet, a headgear, a hat, and so on.

The monitoring module 10 can monitor the user's eyeballs (single eye or both eyes) and generate the corresponding eyeball-movement information. In practice, the monitoring module 10 can comprise, but is not limited to, an infrared device, a charge-couple device (CCD) or a complementary metal-oxide semiconductor (CMOS) device.

The sensing module 12 can sense a body portion of the user, for example but the body portion is not limited to the head, comprising the specific spot on the user's face like the nose, the lips, the eyebrows, the chin, the cheeks, the neck, the Adam's apple, etc.; specific parts of the body like the shoulders, the hands, the feet or other suitable parts. And, the sensing module 12 generates a corresponding body portion-movement information according to the movement of the body portion. In practice, the sensing module 12 can comprise but is not limited to a g-sensor.

The first processing module 14 is connected with the monitoring module 10 and the sensing module 12 respectively, for receiving the eyeball-movement information from the monitoring module 10 and receiving the body portion-movement information from the sensing module 12. And, the first processing module 14 synchronizes the eyeball-movement information and the body portion-movement information; then, it calculates a control movement information in accordance with the eyeball-movement information and the body portion-movement information.

In practice, the first processing module 14 can add the eyeball-movement information into the body portion-movement information, and according to which, it calculates the control movement information. Or, the first processing module 14 can also select the eyeball-movement information or the body portion-movement information as a foundation for calculating the control movement information based on a plurality of principles. For example, when the movement of the eyeball is smaller than a predetermined value, it uses the body portion-movement information as the calculation foundation. On the contrary, when the body portion-movement is smaller than a predetermined value, it uses the eyeball-movement information as the calculation foundation.

The first transmitting module 16 is connected with the first processing module 14, for transmitting the control movement information to the electronic apparatus 2. The electronic apparatus 2, after receiving the control movement information, carries on an action according to the control movement information. For example, when the electronic apparatus 2 is a computer, the action can be the movement of the cursor opposite to the screen.

In practice, the first transmitting module 16 can be a wireless transmitting module, such as a wireless network transmitting module, a bluetooth transmitting module, a radio frequency transmitting module, an infrared transmitting module or other suitable one; it can be also a wire transmitting module, such as a USB transmitting module, IEEE 1394 transmitting module or other suitable ones.

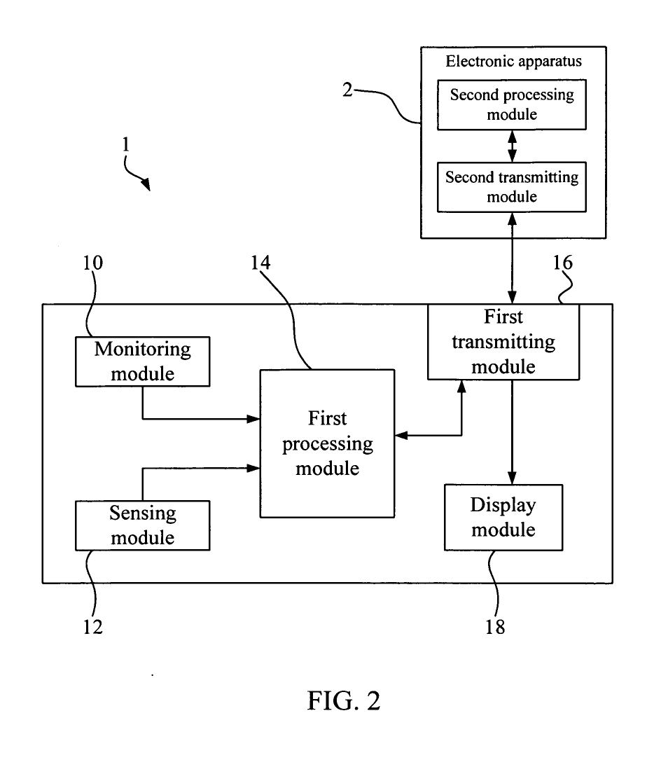

Please refer to FIG. 2, which is a functional block diagram illustrating the control apparatus according to another embodiment of the invention. As shown in FIG. 2, in the embodiment, the control apparatus 1 of the invention further comprises a display module 18, which is not limited to a binocular display module in one example. The display module 18 is connected to the electronic apparatus 2 and is for the receiving and the displaying of an image related to the action.

As shown in FIG. 2, the electronic apparatus 2 in the embodiment comprises a second transmitting module 24 and a second processing module 26. The second transmitting module 24 receives the control movement information from the first transmitting module 16. In practice, the second transmitting module 24 can be like the mentioned wireless or wire transmitting module. Besides, the second processing module 26 is connected to the second transmitting module 24, for generating a control signal according to the control movement information. After that, the second processing module 26 controls the electronic apparatus 2 to carry on the action according to the control signal. In addition, in practice, the second processing module 26 feeds back an image related to the action to the control apparatus 1, and then the display module 18 shows the image.

For example, the electronic apparatus 2 is a computer, which transmits the image displayed on the computer's screen to the display module 18 through wire or wireless transmitting. Hence, when the user controls the move of the cursor on the computer's screen via the control apparatus 1 of the invention, the computer feeds back the moving process to the display module 18 and shows it to the user immediately.

In another embodiment, the electronic apparatus 2 is a TV game. The TV game transmits the game images which are to be showed on TV to the display module 18 through wire or wireless transmitting. The monitoring module 10, the first processing module 14 and the first transmitting module 16 are integrated as a pair of glasses worn by a user, and the sensing module 12 is set on one hand of the user separately. The sensing module 12 transmits the hand-movement information to the first processing module 14 by the method of wireless or wire transmitting. The eyeball-movement information obtained from the monitoring module 10 and the hand-movement information obtained from the sensing module 12 are dealt with via the first processing module 14, and are transmitted to the TV game to be an operating instruction of the game for the user. The second transmitting module 24 of the TV game receives and deals with the operating instruction from the transmitting module 16, and then feeds back the corresponding game image to the display module 18 for the user's immediate watch.

In practice, the processing module of the control apparatus or the electronic apparatus in the invention comprises a storage unit for saving in advance a contrast table which records a plurality of control movement information and a plurality of control information corresponding respectively to the control movement information. When the storage unit is set in the first processing module of the control apparatus, the first processing module compares the control movement information obtained from calculation with the plurality of control movement information stored in the contrast table. If there is a matched control movement information, the corresponding control information will be collected and transmitted to the electronic apparatus.

Besides, when the storage unit is set in the second processing module of the electronic apparatus, the second processing module receives the control movement information, compares the control movement information with the plurality of control movement information stored in the contrast table, and generates the control signal according to the control information. Taking advantage of this, the control apparatus or the electronic apparatus can find out the corresponding control information by table look-up and there is no need to carry on the related calculation; it reduces the reaction time and saves the hardware resources.

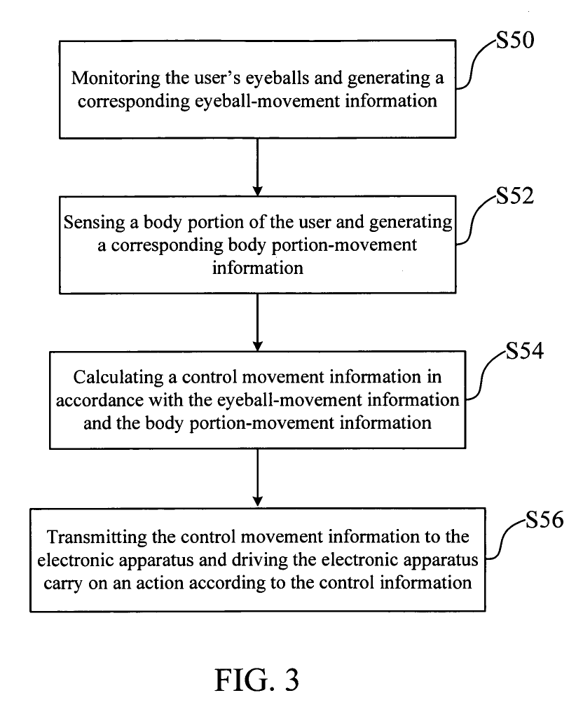

Please refer to FIG. 3, which is a flow chart illustrating the control method according to an embodiment of the invention. The control method of the invention is for a user to control the electronic apparatus as mentioned above.

As shown in FIG. 3, the control method comprises the following steps: firstly, in step S50, monitoring the user's eyeballs and generating a corresponding eyeball-movement information. Afterward, in step S52, sensing a body portion of the user, like said head, neck or other suitable body portion of the user, and generating a corresponding body portion-movement information. Consequently, in step S54, calculating a control movement information in accordance with the eyeball-movement information and the body portion-movement information. Finally, in step S56, transmitting the control movement information to the electronic apparatus, for example, by suitable wireless or wire transmitting and driving the electronic apparatus to carry on an action according to the control information.

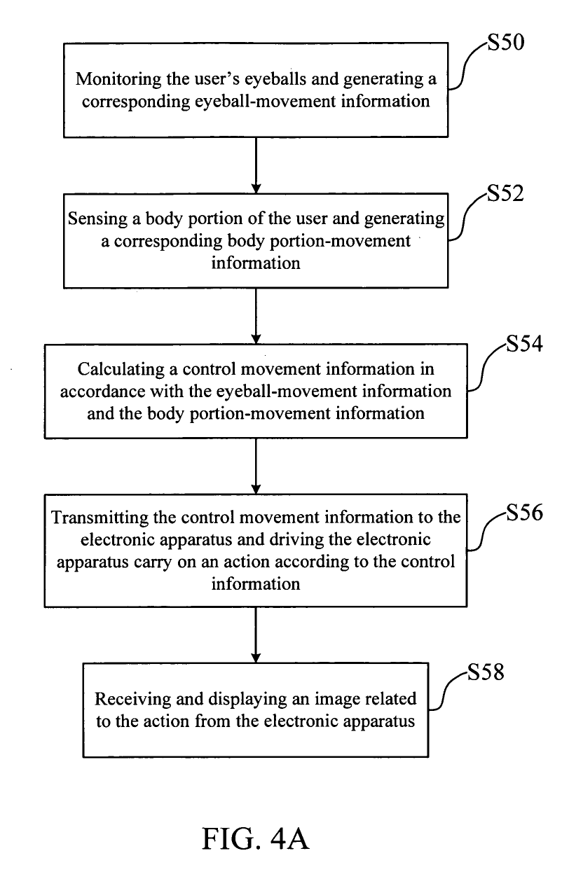

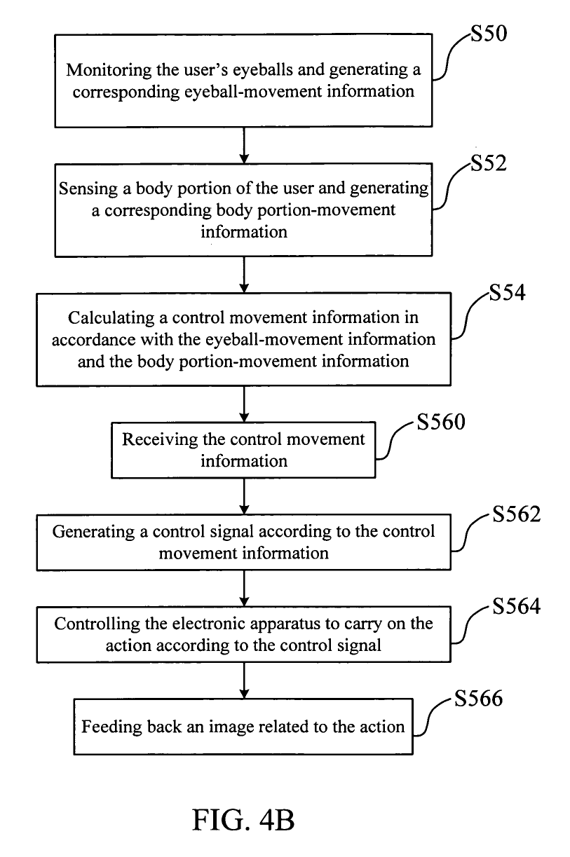

Please refer to FIG. 4A, which is a flow chart illustrating the control method according to an embodiment of the invention. As shown in FIG. 4A, the control method of the invention further comprises step S58: receiving and displaying an image related to the action from the electronic apparatus.

Please refer to FIG. 4B, which is a flow chart illustrating the control method according to an embodiment of the invention. As shown in FIG. 4B, said step S56 further comprises the following steps: step S560, receiving the control movement information; Step S562, generating a control signal according to the control movement information; Step S564, controlling the electronic apparatus to carry on the action according to the control signal. And step S566, feeding back an image related to the action.

To sum up, besides monitoring the movement of the eyeballs, the control apparatus and the control method of the invention combine the sensing module to detect the body portion of the user, so as to solve the disadvantage in prior art to carry on the control alone by the eyeball-movement information. Therefore, the control apparatus and the control method of the invention provide a more accurate and more elastic control model to facilitate the user to control the corresponding electronic apparatus.

Although the present invention has been illustrated and described with reference to the preferred embodiment thereof, it should be understood that it is in no way limited to the details of such embodiment but is capable of numerous modifications within the scope of the appended claims.

What is claimed is:

1. A control apparatus for a user to control an electronic apparatus, the control apparatus comprising:
a monitoring module for monitoring the user's eyeballs and generating a corresponding eyeball-movement information;
a sensing module for sensing a body portion of the user, and generating a corresponding body portion-movement information;
a first processing module connected with the monitoring module and the sensing module, respectively, for calculating a control movement information in accordance with the eyeball-movement information and the body portion-movement information; and
a first transmitting module connected with the first processing module, for transmitting the control movement information to the electronic apparatus; wherein the electronic apparatus carries on an action according to the control information.

2. The control apparatus of claim 1, further comprising:
a display module connected with the electronic apparatus, for receiving and displaying an image related to the action.

3. The control apparatus of claim 2, wherein the display module is a binocular display module (BDM).

4. The control apparatus of claim 1, wherein the electronic apparatus further comprising:
a second transmitting module for receiving the control movement information from the first transmitting module; and
a second processing module connected with the second transmitting module, for generating a control signal according to the control movement information, controlling the electronic apparatus to carry on the action according to the control signal, and feeding back an image that relates the action to the control apparatus.

5. The control apparatus of claim 4, wherein the second transmitting module is a wireless transmitting module selected from a group consisting of a wireless network transmitting module, a bluetooth transmitting module, a radio frequency transmitting module and an infrared transmitting module.

6. The control apparatus of claim 1, wherein the monitoring module comprises an infrared device, a charge-couple device (CCD) or a complementary metal-oxide semiconductor (CMOS) device.

7. The control apparatus of claim 1, wherein the sensing module comprises a g-sensor.

8. The control apparatus of claim 1, wherein the body portion comprises the head, neck, shoulder, a hand or a foot of the user.

9. The control apparatus of claim 1, wherein the first transmitting module is a wireless transmitting module selected from a group consisting of a wireless network transmitting module, a bluetooth transmitting module, a radio frequency transmitting module and an infrared transmitting module.

10. The control apparatus of claim 1, wherein the monitoring apparatus, the sensing module, the first processing module and the first transmitting module are integrated on a wearable structure.

11. The control apparatus of claim 10, wherein the wearable structure is capable of being worn on the user's head.

12. A control method for a user to control an electronic apparatus, the control method comprising:
(A) monitoring the user's eyeballs and generating a corresponding eyeball-movement information;
(B) sensing a body portion of the user and generating a corresponding body portion-movement information;
(C) calculating a control movement information in accordance with the eyeball-movement information and the body portion-movement information; and
(D) transmitting the control movement information to the electronic apparatus and driving the electronic apparatus to carry on an action according to the control information.

13. The control method of claim 12, further comprising:
(E) receiving and displaying an image that relates the action to the electronic apparatus.

14. The control method of claim 12, wherein step (D) further comprising:
(D1) receiving the control movement information;
(D2) generating a control signal according to the control movement information;
(D3) controlling the electronic apparatus to carry on the action according to the control signal; and
(D4) feeding back an image related to the action.

15. The control method of claim 12, wherein the control movement information is transmitted via wireless transmission to the electronic apparatus.

16. The control method of claim 12, wherein the body portion comprises head, neck, shoulder, a hand or a foot of the user.
